(19) United States
(12) Patent Application Publication
(10) Pub. No.: US 2023/0317102 A1
(43) Pub. Date: Oct. 5, 2023

(54) Sound Event Detection

(71) Applicant: Meta Platforms Technologies, LLC, Menlo Park, CA (US)

(72) Inventors: Cagdas Bilen, Cambridge (GB); Giacomo Ferroni, Cambridge (GB); Juan Azcaretta Ortiz, Cambridge (GB); Francesco Tuveri, Cambridge (GB); Sacha Krstulovic, Cambridge (GB)

(21) Appl. No.: 17/713,919

(22) Filed: Apr. 5, 2022

(51) Int. Cl. G10L 25/87; G10L 25/30; G06N 3/04

(52) U.S. Cl. CPC G10L 25/87; G06N 3/04; G10L 25/30

(57) ABSTRACT

A method of detecting occurrences of a sound event in an audio signal comprising a sequence of frames of audio data, each frame corresponding to a respective time in the audio signal, the method comprising: for each frame in the sequence: determining, using the audio data of the frame, a first conditional probability value that a transition occurred from a sound event not having started to the sound event being ongoing, and a second conditional probability value that a transition occurred from a sound event being ongoing to the sound event having ended; and determining a marginal probability value that a sound event was ongoing at the time corresponding to the frame, the marginal probability value being determined using the first and second conditional probability values for the frame and a previously determined marginal probability value that a sound event was ongoing at a time corresponding to a frame preceding the frame in the sequence.

### FIELD

This disclosure relates to systems, methods and computer program code for detecting occurrences of sound events in audio signals, and to related applications of such techniques.

### BACKGROUND

Example background information on sound recognition systems and methods can be found in the applicant's PCT application WO2010/070314, which is hereby incorporated by reference in its entirety.

### SUMMARY

According to a first aspect there is provided a method of detecting occurrences of a sound event in an audio signal comprising a sequence of frames of audio data. Each frame corresponds to a respective time in the audio signal. The method may comprise, for each frame in the sequence, determining, using the audio data of the frame, a first conditional probability value that a transition occurred from a sound event not having started to the sound event being ongoing. The method may further comprise, for each frame in the sequence, determining, using the audio data of the frame, a second conditional probability value that a transition occurred from a sound event being ongoing to the sound event having ended. The method may further comprise, for each frame in the sequence, determining a marginal probability value that a sound event was ongoing at the time corresponding to the frame. The marginal probability value may be determined using the first and second conditional probability values for the frame and a previously determined marginal probability value that a sound event was ongoing at a time corresponding to a frame preceding the frame in the sequence.

As the marginal probability value that a sound event was ongoing at the time corresponding to the frame is determined using the corresponding marginal probability determined for the preceding frame, the method may be able to detect occurrences of sound events in audio data more reliably compared to existing sound event detection methods. For example, existing methods may perform poorly when the input audio data is “noisy” such that multiple transitions corresponding to the onset of a sound event are detected when the audio data is processed, even though in reality only a single sound event took place. However, the present method may account for such possibilities using a marginal probability value that a sound event was ongoing that is updated each time a frame is processed. The present method may therefore make use of information obtained by processing frames earlier in the sequence to provide a more reliable estimate of whether an event was ongoing at the time corresponding to the frame currently being processed. The first and second conditional probabilities for each frame may be determined using acoustic models that are already known in the art. The method may be implemented to improve existing methods that use such acoustic models, by incorporating an additional processing step of determining the marginal probability value that a sound event was ongoing for each frame. The present method may therefore be applied to improve existing systems for detecting sound events. The respective marginal probability values that a sound event was ongoing for each frame may also be used to train the acoustic models more effectively.

A sound event may be a sound resulting from an event and/or action. Examples of a sound event may be a baby crying, a gun shooting, a dog barking, or a person talking. A method for recognising occurrences of a sound event in an audio signal may include a method that comprises determining that a person is speaking (or other details such as when a person has started and stopped speaking, or determining that more than one person is speaking). In some cases, the sound event may be a non-verbal sound event, such that methods for detecting occurrences of a sound event in an audio signal may not comprise methods of recognising and, for example transcribing, exact words of speech.

A probability value may be a number indicative of the likelihood of some event occurring or having occurred. In some cases, a probability value may be a probability, in which case the probability value is a positive number less than or equal to one. In other cases, a probability value may refer to a relative likelihood of an event occurring, or having occurred, relative to some other event occurring of having occurred, in which case the probability value may be greater than one.

A conditional probability may refer to a probability for an event occurring or having occurred under an assumed context or constraint, e.g. another event having happened before the event. For example, a conditional probability that a transition occurred from a sound event not having started to the sound event being ongoing refers to the probability that a sound event started given that the sound event had not already started. Similarly, a conditional probability that a transition occurred from a sound event being ongoing to the sound event having ended refers to probability that a sound event ended given that a sound event was ongoing. By contrast, a marginal probability refers to a probability for an event occurring or having occurred irrespective of a context or constraint, e.g. a probability of a sound event having started irrespective of whether the sound event is assumed to be ongoing or not. A marginal probability for an event A may be expressed in terms of conditional probabilities for A given another event B as follows: P(A)=P(A given B) P(B)+P(A given not B) P(not B).

An audio signal may be an analogue or digital audio signal captured by a sound capturing device such as a microphone. If the audio signal is an analogue signal then the method may comprise converting the analogue signal into a digital signal using, for example, an Analog to Digital Converter (ADC). The sound capturing device may be a microphone array, in which case multi-channel audio can be captured and may be used to obtain improved sound recognition results.

The audio signal may be defined as a sequence of frames. Each frame may cover a time interval, as one particular example, approximately 0.032 s of sound sampled every 0.016 s. The sequence denotes that the frames have a chronological order. The frames may be samples taken at regular intervals from a continuous time series (such as a time series of the audio signal samples). As the samples (i.e. frames) may be taken at regular intervals, e.g. defined by a sampling rate, time may be equivalently expressed in standard time units (i.e., minutes, seconds, milliseconds etc.) or as a number of frames. For example, in a digital system where the sampling rate is 16 kHz (which means 16,000 samples per second), a duration of 16 milliseconds can be equivalently expressed as 256 samples: 0.016 seconds times 16,000 samples per second equals 256 samples.

The frames of audio data may contain time domain waveform samples or Fourier domain spectrum samples. The frames of audio data may comprise one or more time domain waveform samples or one or more Fourier domain spectrum samples e.g. STFT (short-time Fourier transform) samples.

The first and second conditional probability values may be determined using audio data of frames of a subsequence comprising the frame and one or more other frames of the sequence. In other words, the first and second conditional probability values may be determined using, in addition to the audio data of the frame currently being processed, the audio data of one or more frames of the sequence that neighbour or are otherwise adjacent to the frame currently being processed. In some implementations, the subsequence comprising the frame and the one or more other frames of the sequence has a fixed length. The subsequence may be generally centred on the frame currently being processed, such that the first and second conditional probability values are determined using audio data from both before and after the time corresponding to the frame currently being processed. Alternatively, the frame currently being processed may be towards or at either end of the subsequence.

In some implementations, there may be a one-to-one correspondence between frames obtained by sampling the audio signal and the marginal probability values determined by the method, i.e. first and second conditional probability values and a marginal probability value that a sound event was ongoing at the time corresponding to the frame are determined for each of the sampled frames. In other implementations, marginal probability values that a sound event was ongoing at the time corresponding to the frame may be determined for only a subset of the sampled frames. For example, a marginal probability value that a sound event was ongoing at the time corresponding to the frame may be determined for every 10th, 100th or 1000th sampled frame. The subset of frames may be selected from the sampled frames using, for example, a constant step size, or an adaptive step size that depends on the sampled audio data, or some other criterion.

The first and second conditional probability values are determined by processing the frame (or frames) of audio data. Processing a frame of audio data may comprise processing one or more of a time domain waveform sample and a Fourier domain waveform sample, where the time domain waveform sample and Fourier domain waveform sample correspond to audio from a same point in time in the audio signal. The result of processing may be one or several vector(s) of acoustic features. Processing a frame of audio data may comprise performing one or more signal processing algorithms on the frame of audio data. Additionally or alternatively, processing a frame of audio data may comprise using a regression method. The regression method may consist in feature learning. Feature learning may be implemented, e.g., by training an artificial neural network (ANN) to produce acoustic features.

One or more of the extracted acoustic features may be a ideophonic feature such as an acoustic feature representing a level of ‘beepiness’ associated with a frame of audio data (other examples may be a level of ‘suddenness’ or ‘harmonicity’).

A single acoustic feature vector can comprise all of the extracted acoustic features for a frame.

Extracting a variety of features is advantageous because it can provide for more accurate classification of the frame.

A neural network used to process the audio data of the frame(s) may be referred to as a sound event detection neural network. Determining the first and second conditional probability values may therefore comprise providing the audio data of the frame to a sound event detection neural network to generate respective values indicative of a likelihood that the audio data contains a transition from a sound event not having started to the sound event being ongoing and a transition from a sound event being ongoing to the sound event having ended. In such cases, the first and second conditional probability values are derived from (e.g. equal to) the values generated by the sound event detection neural network.

The sound event detection neural network may comprise one or more feedforward neural networks, or one or more convolutional neural networks (CNNs) i.e. a neural network with one or more convolutional layers, or a combination thereof. In some implementations, the sound event detection neural network may comprise a recurrent neural network.

The sound event detection neural network may comprise a feature extraction neural subnetwork to extract acoustic features from the audio data of the frame, as described above.

The sound event detection neural network may comprise a classification neural subnetwork configured, e.g. trained, to receive a vector of acoustic features from the feature extraction neural subnetwork and to generate a score for each of a plurality of sound classes, wherein the first and second conditional probability values are determined using a score for at least one of the sound classes. The score may be a probability, in which case a summation of the score for each of the set of sound classes equals one.

Thus, in some implementations the sound event detection neural network may be configured to receive a representation of a frame of the audio signal and to process the representation in accordance with parameters e.g. weights of the sound event detection neural network, to generate an output for classifying a sound event represented by the audio signal into one of a plurality of categories. For example, the output may comprise two sets of scores, one set of scores for each of the sound event categories. In implementations, a first set of scores represents, for each category, a conditional probability that the sound event started during the audio signal frame (i.e. that a transition occurred from the sound event not having started to the sound event being ongoing); and a second set of scores represents, for each category, a conditional probability that the sound event stopped during the audio signal frame (i.e. that a transition occurred from the sound event being ongoing to the sound event having ended).

A sound class is a sound that can be recognised from an audio signal by the described method. Sound classes can be representative of, indicators of, or associated with, sound events, for example a sound class may be “baby crying”, “dog barking” or “female speaking”.

In some implementations, the method may comprise, determining, for one or more of the frames, a start-transition marginal probability value that a sound event started at the time corresponding to the frame. The start-transition marginal probability value is determined using the first conditional probability value for the frame and the marginal probability value that a sound event was ongoing at the time corresponding to the frame. The method may also comprise, in some cases, determining, for one or more of the frames, an end-transition marginal probability value that a sound event ended at the time corresponding to the frame. The end-transition marginal probability value is determined using the second conditional probability value for the frame and the marginal probability value that a sound event was ongoing at the time corresponding to the frame.

According to another aspect there is provided a non-transitory data carrier carrying processor control code which when running on a device causes the device to perform any of the above method steps.

According to another aspect there is provided a computer system configured to implement any of the above method steps.

According to another aspect there is provided a consumer electronic device comprising the above computer system.

According to another aspect there is provided a system for detecting occurrences of a sound event in an audio signal comprising a sequence of frames of audio data. The system comprising one or more processors. The one or more processors may be configured to, for each frame in the sequence, determine, using the audio data of the frame, a first conditional probability value that a transition occurred from a sound event not having started to the sound event being ongoing, and a second conditional probability value that a transition occurred from a sound event being ongoing to the sound event having ended. The one or more processors may be further configured to, for each frame in the sequence, determine a marginal probability value that a sound event was ongoing at a time corresponding to the frame, the marginal probability value being determined using the first and second conditional probability values for the frame and a previously determined marginal probability value that a sound event was ongoing at a time corresponding to a frame preceding the frame in the sequence. The system may further comprise a microphone to capture the audio data.

According to another aspect there is provided an acoustic model implemented by one or more computers. The acoustic model is configured to receive a sequence of frames of audio data and to provide an output for each of the frames. The acoustic model may comprise a sound event detection neural network configured to: receive the frames; and, for each of the frames, determine, using the audio data of the frame, a first conditional probability value that a transition occurred from a sound event not having started to the sound event being ongoing, and a second conditional probability value that a transition occurred from a sound event being ongoing to the sound event having ended. The acoustic model may further comprise a recurrent layer or function configured to, for each of the frames: receive the first and second conditional probability values from the sound event detection neural network and determine a marginal probability value that a sound event was ongoing at a time corresponding to the frame. The marginal probability value is determined using the first and second conditional probability values for the frame and a previously determined marginal probability value that a sound event was ongoing at a time corresponding to a frame preceding the frame in the sequence. The recurrent layer or function may store the marginal probability value that a sound event was ongoing at the time corresponding to the frame for use in determining the marginal probability value that a sound event was ongoing at a time corresponding to the next frame in the sequence. The recurrent layer or function may be configured to provide the marginal probability value as the output for the frame.

According to another aspect there is provided a method of training the acoustic model. The method may comprise providing a sequence of frames of audio data and labels identifying for which of the frames a sound event was ongoing and using the acoustic model to obtain, for each of the frames, a marginal probability value that a sound event was ongoing at a time corresponding the frame. The method may comprise adjusting weights of the sound event detection subnetwork based on the marginal probability values and the labels identifying for which of the frames a sound event was ongoing. Adjusting the weights may comprise optimizing a value of an objective function, e.g. minimising a loss determined using a loss function that compares the marginal probability value with the “ground truth” for each frame provided by the labels. The loss function may comprise a categorical cross-entropy loss function, although many other types of loss function can be used.

The output for each frame may comprise a start-transition marginal probability value that a sound event started at the time corresponding to the frame, the start-transition marginal probability value being determined using the first conditional probability value for the frame and the marginal probability value that a sound event was ongoing at the time corresponding to the frame. The output for each frame may further (or alternatively) comprise an end-transition marginal probability value that a sound event ended at the time corresponding to the frame, the end-transition marginal probability value being determined using the second conditional probability value for the frame and the marginal probability value that a sound event was ongoing at the time corresponding to the frame. The method of training the acoustic model may further comprise adjusting the weights of the sound event detection neural network using the start-transition and end-transition marginal probability values.

According to another aspect there is provided a sound recognition device comprising one or more computers configured to implement the above acoustic model and one or more microphones to capture the audio data.

In a related aspect there is provided a non-transitory data carrier carrying processor control code which when running on a device causes the device to operate as described.

According to a further aspect there is provided a method of detecting occurrences of an event in a time series comprising a plurality of data points. Each data point comprises data for a corresponding time in the time series. The method may comprise, for each data point in the sequence, determining, using the data for the data point, a first conditional probability value that a transition occurred from an event not having started to the event being ongoing. The method may further comprise, for each data point in the sequence, determining, using the data for the data point, a second conditional probability value that a transition occurred from an event being ongoing to the event having ended. The method may comprise determining a marginal probability value that an event was ongoing at the time corresponding to the data point, the marginal probability value being determined using the first and second conditional probability values for the data point and a previously determined marginal probability value that an event was ongoing at a time corresponding to a data point preceding the data point in the time series.

The time series may be a sequence of frames of audio and/or video data.

It will be appreciated that the functionality of the devices we describe may be divided across several modules and/or partially or wholly implemented in the cloud. Alternatively, the functionality may be provided in a single module or a processor. The or each processor may be implemented in any known suitable hardware such as a microprocessor, a Digital Signal Processing (DSP) chip, an Application Specific Integrated Circuit (ASIC), Field Programmable Gate Arrays (FPGAs), a Graphical Processing Unit (GPU), a Tensor Processing Unit (TPU), and so forth. The or each processor may include one or more processing cores with each core configured to perform independently. The or each processor may have connectivity to a bus to execute instructions and process information stored in, for example, a memory.

The aforementioned neural networks used to detect occurrences of a sound event may be trained separately. Alternatively, the aforementioned neural networks used to detect occurrences of a sound event may be considered as a neural network system that can be trained (i.e., back-propagated) end-to-end. This may be considered to be a single neural network or may be considered to be a chain of modules trained jointly.

The invention further provides processor control code to implement the above-described systems and methods, for example on a general-purpose computer system, a digital signal processor (DSP) or a specially designed math acceleration unit such as a Graphical Processing Unit (GPU) or a Tensor Processing Unit (TPU). The invention also may provide a carrier carrying processor control code to, when running, implement any of the above methods, in particular on a non-transitory data carrier—such as a disk, microprocessor, CD- or DVD-ROM, programmed memory such as read-only memory (Firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit), FPGA (Field Programmable Gate Array), GPU (Graphical Processing Unit), TPU (Tensor Processing Unit) or NPU (Neural Processing Unit), or code for a hardware description language such as Verilog™ or VHDL (Very high speed integrated circuit Hardware Description Language). As the skilled person will appreciate such code and/or data may be distributed between a plurality of coupled components in communication with one another.

The invention may comprise a controller that includes a microprocessor, working memory and program memory coupled to one or more of the components of the system. The invention may comprise performing a DNN operation on a GPU and/or an AI accelerator microprocessor, and performing other operations on a further processor.

These and other aspects will be apparent from the embodiments described in the following. The scope of the present disclosure is not intended to be limited by this summary nor to implementations that necessarily solve any or all of the disadvantages noted.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

Embodiments of the invention will be described, by way of example, with reference to the accompanying drawings, in which:

FIG. 1 is a block diagram of a system 100 configured to detect occurrences of sound event in an audio signal.

FIG. 2 is a schematic flow diagram of a method 200 of detecting occurrences of a sound event in an audio signal comprising a sequence of frames of audio data.

FIG. 3 is a schematic diagram of a system 300 comprising a recurrent module 305, the system being configured to detect occurrences of an event in in an audio signal comprising a sequence of frames of audio data.

FIG. 4 is a schematic diagram showing the operations performed by the recurrent module 305 of FIG. 3.

FIG. 5 shows a process 500 for training the machine learning models (e.g. neural network(s)) of the event detector 301 of FIG. 3.

FIG. 6 shows sample output for sound events corresponding to a plurality of sound classes from an event detection system not incorporating a recurrent module 305.

FIG. 7 shows corresponding sample output for the event detection system of FIG. 6 after a recurrent module 305 has been added.

### DETAILED DESCRIPTION OF THE DRAWINGS

Embodiments will now be described by way of example only.

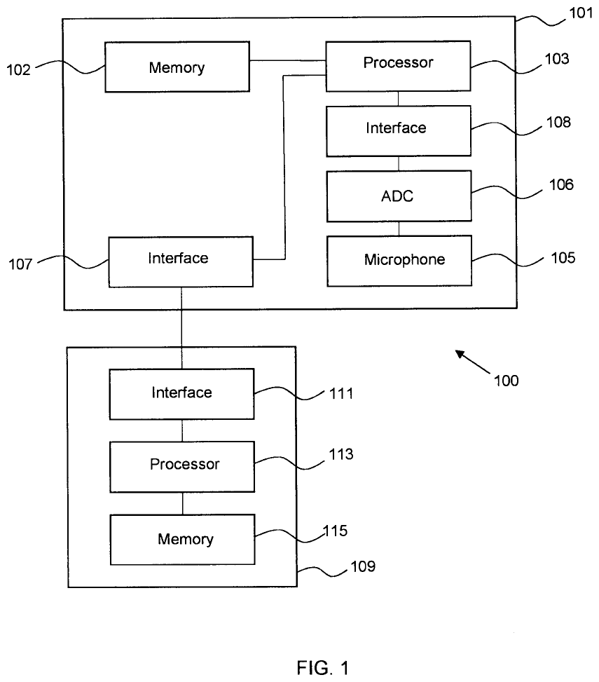

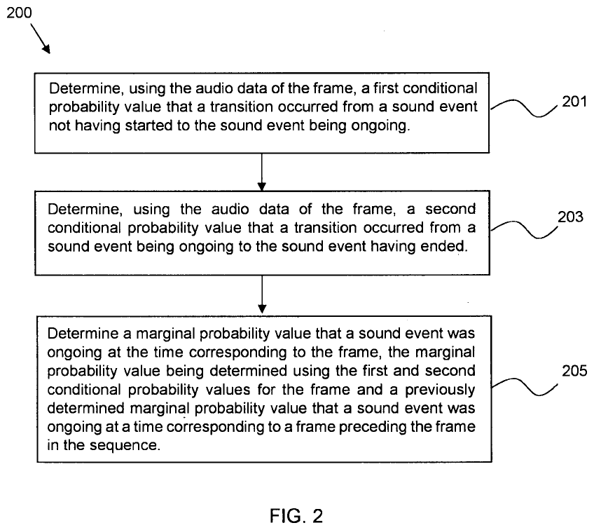

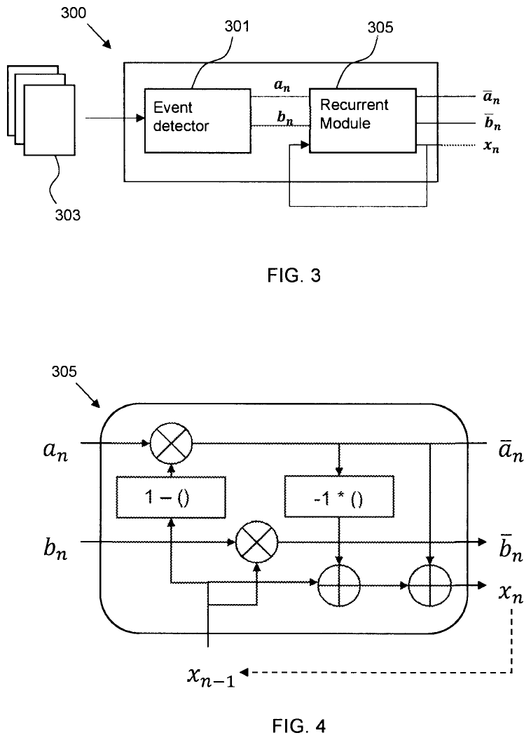

FIG. 1 shows a system 100 configured to detect occurrences of a sound event. The system comprises a device 101. The device 101 may be any type of electronic device. The device 101 may be a consumer electronic device. For example, the consumer electronic device 101 may be a smartphone, a headphone, a smart speaker, a car, a digital personal assistant, a personal computer, a tablet computer. The device 101 comprises a memory 102, a processor 103, a microphone 105, an analogue to digital converter (ADC) 106, an interface 107 and an interface 108. The processor is in connection to: the memory 102; the microphone 105; the analogue to digital converter (ADC) 106; interface 108; and the interface 107. The processor 103 is configured to detect occurrences of a sound event by running computer code stored on the memory 102. For example, the processor 103 is configured to perform the method 200 of FIG. 2. The processor 103 may comprise one or more of a CPU module and a DSP module. The memory 102 is configured to store computer code that when executed by the processor 103, causes the processor to detect occurrences of a sound event.

The microphone 105 is configured to convert a sound into an audio signal. The audio signal may be an analogue signal, in which case the microphone 106 is coupled to the ADC 106 via the interface 108. The ADC 106 is configured to convert the analogue audio signal into a digital signal. The digital audio signal can then be processed by the processor 103. In embodiments, a microphone array (not shown) may be used in place of the microphone 105.

Although the ADC 106 and the microphone 105 are shown as part of the device 101, one or more of the ADC 106 and the microphone 105 may be located remotely to the device 101. If one or more of the ADC 106 and the microphone 105 are located remotely to the device 101, the processor 103 is configured to communicate with the ADC 106 and/or the microphone 105 via the interface 108 and optionally further via the interface 107.

The processor 103 may further be configured to communicate with a remote computing system 109. The remote computing system 109 is configured to detect occurrences of a sound event, therefore the processing steps required to detect occurrences of a sound event may be spread between the processor 103 and the processor 113. The remote computing system comprises a processor 113, an interface 111 and a memory 115. The interface 107 of the device 101 is configured to interact with the interface 111 of the device 109 so that the processing steps required to detect occurrences of a sound event may be spread between the processor 103 and the processor 113.

FIG. 2 shows a method 200 of detecting occurrences of a sound event in an audio signal comprising a sequence of frames of audio data. The method 200 can be performed by the processor 103 in FIG. 1, or can be split between several processors, for example processors 103 and 113 in FIG. 1. The audio signal may have been acquired by a microphone, for example microphone 105 of FIG. 1. The audio signal may have been converted from an analogue signal to a digital signal by an analogue to digital converter, for example by the analogue to digital converter (ADC) 106 in FIG. 1. The processor 103 is configured to receive the digital signal from the ADC 106 via an interface 108. The microphone 105 and analogue-to-digital (ADC) converter 106 may deliver digital audio signal to the processor 103 via the interface 108, for example a serial interface such as 120. The sampling frequency may be 16 kHz, this means that 16,000 audio samples are taken per second. Samples of the audio signal may be grouped into a series of 32 ms long frames with 16 ms hop size. If the sampling frequency is 16 kHz, then this is equivalent to audio samples being grouped into a sequence of frames that comprise 512 audio samples with a 256 audio samples-long hop size. Each frame corresponds to a respective time in the audio signal and may, for example, be a time at which the first or the last of audio samples in the group was acquired, or a median of the times at which the audio samples in the group were acquired.

In some implementations, feature extraction is performed on the frames to transform the audio data of each frame into a multidimensional feature vector, i.e. the audio data for each frame may not be the “raw” audio data obtained by sampling, but rather a representation of that data in terms of a plurality of features. In some implementations, a feature vector stacking step may be applied to the feature vectors. The feature vector stacking step comprises concatenating the acoustic feature vectors into larger acoustic feature vectors. The concatenation comprises grouping adjacent feature vectors into one longer (i.e. a higher dimensional) feature vector. For example, if an acoustic feature vector comprises 32 features, the feature vector stacking step may produce a 352 dimension stacked feature vector by concatenating an acoustic feature vector with 5 acoustic feature vectors before and after the considered acoustic feature vector (352 dimensions=32 dimensions×11 frames, where 11 frames=5 preceding acoustic feature vector+1 central acoustic feature vector+5 following acoustic feature vectors).

The feature extraction can be implemented in a variety of ways. For example, one or more signal processing algorithms may be performed on the frames of the sequence. An example of a signal processing algorithm is an algorithm that processes a power spectrum of the frame to extract a spectral flatness value for the frame. A further example is a signal processing algorithm that extracts harmonics and their relative amplitudes from the frame.

An additional or alternative implementation of feature extraction is to use a Deep Neural Network (DNN) to extract a number of acoustic features for a frame. A DNN can be configured to extract audio feature vectors of any dimension. A bottleneck DNN embedding or any other appropriate DNN embedding may be used to extract acoustic features. Here a neural network bottleneck may refer to a neural network which has a bottleneck layer between an input layer and an output layer of the neural network, where a number of units in a bottleneck layer is less than that of the input layer and less than that of the output layer, so that the bottleneck layer is forced to construct a generalised representation of the acoustic input.

The method 200 comprises steps 201, 203, 203 that are performed for each of the frames in sequence of frames of audio data. In the first of these steps, step 201, the audio data of the frame is used to determine, a first conditional probability value that a transition occurred from a sound event not having started to the sound event being ongoing. In the subsequent step, step 203, the audio data of the frame is used to determine, a second conditional probability value that a transition occurred from a sound event being ongoing to the sound event having ended.

The steps 201, 203 relating to determining the first and second conditional probability values can be performed using acoustic modelling. The acoustic modelling may comprise classifying each frame by determining, for each of a set of sound classes, a score that the frame represents the sound class. For example, the acoustic modelling may comprise using a deep neural network (DNN) trained to classify each incoming stacked or non-stacked acoustic feature vector into a sound class (e.g. glass break, dog bark, baby cry etc.). Therefore, the input of the DNN is an acoustic feature vector and the output is a score for each sound class. The scores for each sound class for a frame may collectively be referred to as a frame score vector. For example, the DNN may be configured to output a score for each sound class modelled by the system every 16 ms.

An example DNN for acoustic modelling is a feed-forward fully connected DNN having 992 inputs (a concatenated feature vector comprising 15 acoustic vectors before and 15 acoustic vectors after a central acoustic vector=31 frames×32 dimensions in total). The example DNN has 3 hidden layers with 128 units per layer and RELU activations.

Alternatively, a convolutional neural network (CNN), a recurrent neural network (RNN) (i.e. a neural network with one or more recurrent neural network layers) and/or some other form of deep neural network architecture or combination thereof can be used.

In some implementations, score warping may be used to reweight the scores according to probabilities learned from application-related data. In other words, the scores output by the DNN may adjusted based on some form of knowledge other than the audio data. The knowledge may be referred to as external information, examples of such external information may include information relating to the audio data being obtained from different sound environments, such as a busy home or workplace, a home in which the occupants are away, a hospital, etc. As examples, score warping may comprise the following method:

using prior probabilities of sound event and/or scene occurrence for a given application to reweight one or more scores. For example, for sound recognition in busy homes, the scores for any sound class related to speech events and/or scenes would be weighted up. In contrast, for sound recognition in unoccupied homes, the scores for any sound class related to speech events and/or scenes would be weighted down.

A sound event may correspond to a particular sound class (or a particular set of sound classes) being detected for the frames of the audio data. For example, a sound class associated with the sound event may have relatively low scores for frames before the sound event, relatively high scores for frames during the sound event and relatively low scores again for frames after the sound event. A transition from a relatively low score to a relatively high score may be detected as the onset or “start-transition” of the sound event. Conversely, a transition from a relatively high score to a relatively low score may be detected as the “end-transition” of the sound event. Transitions associated with large score changes can generally be detected with high confidence and are therefore associated with high conditional probabilities that the detected transitions correspond to the sound event starting or ending. Detecting transitions in audio data (e.g. in feature vectors) may be analogous to, for example, edge detection in images processing and can be performed in a number of ways. For example, the transitions may be detected using a neural network, e.g. a convolutional neural network. The neural network may be configured to receive a frame score vector scores comprising score for each sound class for a frame as an input, and provide first and second conditional probability values as an output for each of the sound classes.

The final step 205 of the method 200 shown in FIG. 2 comprises determining a marginal probability value that a sound event was ongoing at the time corresponding to the frame. The marginal probability value is determined using the first and second conditional probability values for the frame and a previously determined marginal probability value that a sound event was ongoing at a time corresponding to a frame preceding the frame in the sequence. For the first frame in the sequence, there is no such preceding frame, so a predetermined marginal probability value may be used instead. This predetermined marginal probability value may be zero, for example.

For a given sound event, the various quantities determined in the method 200 may be expressed as follows, where n is an integer denoting the position of the frame in the sequence:
aₙ: conditional probability that a transition occurred from the sound event not having started to the sound event being ongoing;
bₙ: conditional probability that a transition occurred from the sound event being ongoing to the sound event having ended; and
xₙ: marginal probability that the sound event is ongoing at the time corresponding to the frame.

In the final step 205 of the method 200, the marginal probability (xₙ) that the sound event is ongoing at the time corresponding to the frame may determined as follows, where xₙ₋₁ is the marginal probability that the sound event was ongoing at a time corresponding to a frame preceding the n^{th} frame in the sequence:

xₙ=xₙ₋₁*(1−bₙ)+(1−xₙ₋₁)

This equation can alternatively be expressed using standard probability notation as:

P(event ongoing)=P(event was ongoing) P(no event ending transition occurred)+P(event was not ongoing) P(event starting transition occurred).

The method 200 may additionally involve determining the following additional quantities:
āₙ: marginal probability that the sound event started at the time corresponding to the frame; and
b̅ₙ: marginal probability that the sound event ended at the time corresponding to the frame;

The marginal probability (aₙ) that the sound event started at the time corresponding to the frame may be determined as follows:

āₙ=aₙ*(1−xₙ)

This equation can alternatively be expressed as:

P(event started)=P(event was not ongoing) P(event starting transition occurred).

Similarly, the marginal probability (b̅ₙ) that the sound event ended at the time corresponding to the frame may be determined as follows:

b̅ₙ=bₙ*xₙ

This equation can alternatively be expressed as:

P(event ended)=P(event was ongoing) P(event ending transition occurred).

FIG. 4 shows a system 300 configured to detect occurrences of a sound event in in an audio signal. The system 300 comprises an event detector 301 configured to receive a sequence of frames of audio data 303 and determine, for each of the frames: a conditional probability (aₙ) that a transition occurred from a sound event not having started to the sound event being ongoing; and a conditional probability (bₙ) that a transition occurred from a sound event being ongoing to the sound event having ended. The system 300 further comprises a recurrent module 305 that receives the conditional probability values determined for each frame by the event detector and determines the marginal probability that marginal probability (xₙ) that a sound event is ongoing at the time corresponding to the frame. The recurrent module 305 stores the marginal probability (xₙ) so that it can be used to update the marginal probability for the subsequent frame. The recurrent module 305 provides the marginal probability (xₙ) as an output. Alternatively or additionally, the recurrent module may determine (and provide as an output) the marginal probability (āₙ) that a sound event started at the time corresponding to the frame and/or the marginal probability (b̅ₙ) that a sound event ended at the time corresponding to the frame.

The event detector 301 may be an acoustic model in some implementations. The event detector 301 may be a neural network, such as a feed-forward neural network (e.g. a convolutional neural network) or a recurrent neural network, in which case, the recurrent module 305 may be referred to as a recurrent layer. In general, the neural network may be a deep neural network i.e. that include one or more hidden layers in addition to an output layer.

FIG. 4 shows the operations performed by the recurrent module 305 to take the conditional probabilities (aₙ, bₙ) determined by the event detector 301 and determine the marginal probabilities (xₙ, āₙ, b̅ₐ).

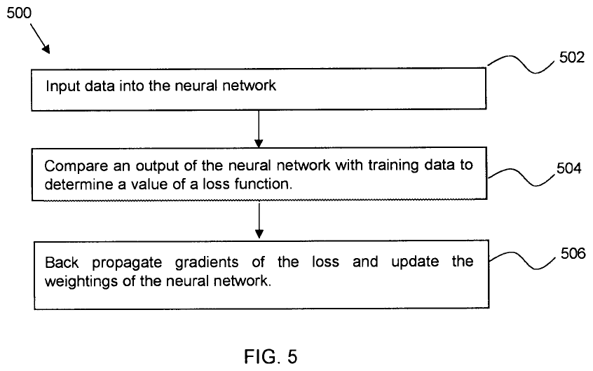

FIG. 5 shows a process 500 for training the event detector 301, which in general is a machine learning model, such as a neural network. In FIG. 5, the event detector 301 is a neural network.

At step 502, data is input into the neural network. In an example, the neural network is configured to receive audio data of multiple frames, transform the audio data into acoustic feature data, determine sound class scores for a frame and output first and second conditional probability values for the frame determined from the sound class scores. The first and second conditional probability values are then provided to the recurrent module 305, which determines and outputs a marginal probability value that a sound event was ongoing at the time corresponding to the frame, as described above. In general, each of the sound classes may correspond to a respective sound event, in which case, the neural network may generate first and second conditional probability values for each of the sound classes, and the recurrent module 305 determines and outputs a marginal probability value for each of the sound events having been ongoing at the time corresponding to the frame. In other words, there may be a one-to-one correspondence between the sound classes and the output marginal probability values.

At step 504, the output of the recurrent module 305 is compared with training data to determine the value of a loss using a loss function. For example, the output marginal probability values for a frame are compared to ground truth (sound event labels) for a frame. A loss is calculated for a sound event corresponding to each of one or more sound classes, preferably a loss is calculated for each of the sound classes.

At step 506, gradients of the value of the loss are back propagated and the parameters, e.g. weights of the neural network, are updated.

An example loss function for training the event detector 301 may be the categorical cross-entropy:

$$- {\sum }_{i} {y}_{i} log {x}_{i}$$

wherein i represents a frame, yᵢ is a sound event label for frame i, and xᵢ represents one or more marginal probability values for frame i output by the recurrent module 305. yᵢ may be ground truth and may be a vector comprising labels for each sound class.

The recurrent module 305 may be regarded as transforming the output of the event detector 301 to facilitate training the machine learning model used by the event detector 301. Neural networks that include recurrent layers, such as long short-term memory (LSTM) layers, may generally require large amounts of training data, at least in part because the weights of the recurrent layers need to be adjusted during training. Although the recurrent module 305 may be implemented as recurrent layer (e.g. as shown in FIG. 4), the recurrent layer does not have weights that need to be adjusted. Thus, the neural network of the event detector 301 may be trained using comparatively less training data than other recurrent neural networks for event detection, whilst providing more robust and reliable event detection than other such recurrent neural networks. Nevertheless, it will be appreciated that the neural network used by the event detector may comprise one or more recurrent layers having adjustable weights.

In the example described with reference to FIG. 5, the event detector 301 is trained using supervised learning, but unsupervised learning may alternatively be used, such that sound classes (and hence events corresponding to the sound classes) can be identified from unlabelled audio data.

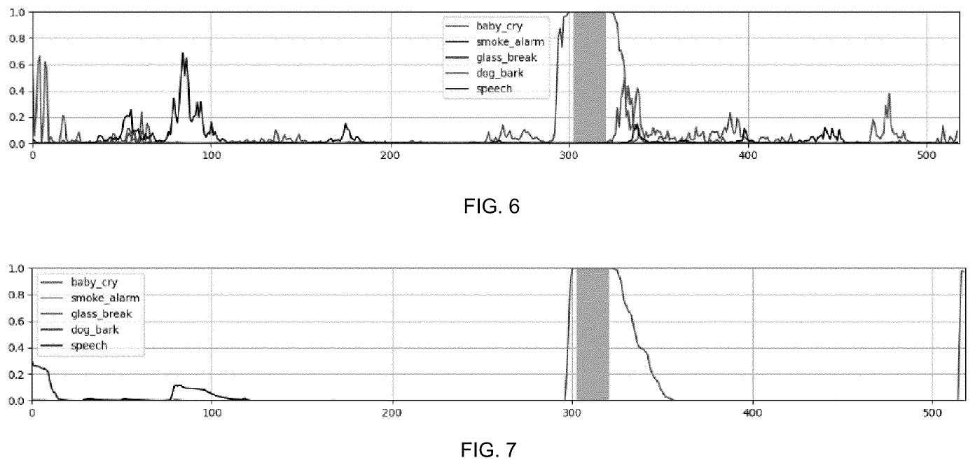

The effect of combining the event detector 301 and the recurrent module 305 can be seen by comparing the output data shown in FIG. 6 with that of FIG. 7. In both figures, the horizontal axis shows the frame index of the audio data, whilst the vertical axis shows a probability that a sound event is ongoing.

FIG. 6 shows probabilities that sound events corresponding to five sound classes are ongoing for each of the frames, the sound classes being associated with a baby crying, a smoke alarm, glass breaking, a dog barking and speech. The probabilities are determined using an event detector 301 that is not combined with a recurrent module 305. In FIG. 7, a corresponding set of probabilities is shown for the same input audio data, the probabilities being determined using the same event detector 305 combined with a recurrent module 305. The shaded region spanning frame indices around 300-315 shown in both figures indicates that these frames are labelled for a “dog bark” event in the audio data.

Although the above description has focused on the detection of sound events, it will be appreciated that the methods and systems described herein may be applied more broadly to other forms of time series data, such as video data. For example, the present methods and systems may be adapted to detect occurrences of a video event in an audio signal comprising sequence of frames of video data. A video event may correspond to a person or object being present within a scene represented by the video data, for example. In such cases, existing image processing techniques may be used to determine whether the person or object is present in the scene. For example, an image recognition neural network, which could be a convolutional neural network, may be used to generate scores that the person or object is present in the scene for each of the frames. Alternatively, the present methods and systems may be used to detect occurrences of an event in time series data generated by a sensor device, such a temperature sensor or an inertial sensor such as an accelerometer and/or gyroscope.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A method of detecting occurrences of a sound event in an audio signal comprising a sequence of frames of audio data, each frame corresponding to a respective time in the audio signal, the method comprising:
for each frame in the sequence:
determining, using the audio data of the frame, a first conditional probability value that a transition occurred from a sound event not having started to the sound event being ongoing, and a second conditional probability value that a transition occurred from a sound event being ongoing to the sound event having ended; and
determining a marginal probability value that a sound event was ongoing at the time corresponding to the frame, the marginal probability value being determined using the first and second conditional probability values for the frame and a previously determined marginal probability value that a sound event was ongoing at a time corresponding to a frame preceding the frame in the sequence.

2. The method according to claim 1, further comprising, for one or more of the frames, determining a start-transition marginal probability value that a sound event started at the time corresponding to the frame, the start-transition marginal probability value being determined using the first conditional probability value for the frame and the marginal probability value that a sound event was ongoing at the time corresponding to the frame.

3. The method according to claim 1, further comprising, for one or more of the frames, determining an end-transition marginal probability value that a sound event ended at the time corresponding to the frame, the end-transition marginal probability value being determined using the second conditional probability value for the frame and the marginal probability value that a sound event was ongoing at the time corresponding to the frame.

4. The method according to claim 1, wherein, for each of the frames, the first and second conditional probability values are determined using audio data of frames of a respective subsequence comprising the frame and one or more other frames of the sequence.

5. The method according to claim 1, wherein determining the first and second conditional probabilities comprises providing the audio data of the frame to a sound event detection neural network to generate respective values indicative of a likelihood that the audio data contains a transition from a sound event not having started to the sound event being ongoing and a transition from a sound event being ongoing to the sound event having ended, the first and second conditional probability values being derived from the generated values.

6. The method according to claim 5, wherein the sound event detection neural network comprises one or more feedforward neural network layers or one or more convolutional neural network layers.

7. The method according to claim 5, wherein the sound event detection neural network comprises a feature extraction neural subnetwork to extract acoustic features from the audio data of the frame.

8. The method according to claim 7, wherein the sound event detection neural network comprises a classification neural subnetwork configured to receive a vector of acoustic features from the feature extraction neural subnetwork and to generate a score for each of a plurality of sound classes, wherein the first and second conditional probabilities are determined using a score for at least one of the sound classes.

9. The method according to claim 1 where a non-transitory data carrier carrying processor control code which when running on a device causes the device to detect the occurrences of the sound event in the audio signal having the sequence of frames of audio data.

10. The method according to claim 1 wherein one or more computer processors in a computer system are configured to detect the occurrences of the sound event in the audio signal having the sequence of frames of audio data.

11. The method according to claim 10 wherein the one or more processors are implemented in a consumer electronic device.

12. A system for detecting occurrences of a sound event in an audio signal comprising a sequence of frames of audio data, the system comprising one or more processors configured to:
for each frame in the sequence:
determine, using the audio data of the frame, a first conditional probability value that a transition occurred from a sound event not having started to the sound event being ongoing, and a second conditional probability value that a transition occurred from a sound event being ongoing to the sound event having ended;
determine a marginal probability value that a sound event was ongoing at a time corresponding to the frame, the marginal probability value being determined using the first and second conditional probability values for the frame and a previously determined marginal probability value that a sound event was ongoing at a time corresponding to a frame preceding the frame in the sequence.

13. An acoustic model implemented by one or more computers, the acoustic model being configured to receive a sequence of frames of audio data and to provide an output for each of the frames, the acoustic model comprising:
a sound event detection neural network configured to:
receive the frames; and
for each of the frames, determine, using the audio data of the frame, a first conditional probability value that a transition occurred from a sound event not having started to the sound event being ongoing, and a second conditional probability value that a transition occurred from a sound event being ongoing to the sound event having ended; and
a recurrent layer or function configured to, for each of the frames:
receive the first and second conditional probability values from the sound event detection neural network and determine a marginal probability value that a sound event was ongoing at a time corresponding to the frame, the marginal probability value being determined using the first and second conditional probability values for the frame and a previously determined marginal probability value that a sound event was ongoing at a time corresponding to a frame preceding the frame in the sequence;
store the marginal probability value that a sound event was ongoing at the time corresponding to the frame for use in determining the marginal probability value that a sound event was ongoing at a time corresponding to the next frame in the sequence; and
provide the marginal probability value as the output for the frame.

14. A method of training the acoustic model of claim 13, the method comprising:
providing a sequence of frames of audio data and labels identifying for which of the frames a sound event was ongoing;
using the acoustic model to obtain, for each of the frames, a marginal probability value that a sound event was ongoing at a time corresponding the frame;
adjusting weights of the sound event detection neural network using the marginal probability values and the labels identifying for which of the frames a sound event was ongoing.

15. The method of training of claim 14, wherein the output for each frame comprises:
a start-transition marginal probability value that a sound event started at the time corresponding to the frame, the start-transition marginal probability value being determined using the first conditional probability value for the frame and the marginal probability value that a sound event was ongoing at the time corresponding to the frame; and
an end-transition marginal probability value that a sound event ended at the time corresponding to the frame, the end-transition marginal probability value being determined using the second conditional probability value for the frame and the marginal probability value that a sound event was ongoing at the time corresponding to the frame, the method further comprising:
adjusting the weights of the sound event detection subnetwork based on the start-transition and end-transition marginal probability values.

16. A sound recognition device comprising one or more computers configured to implement the acoustic model of claim 13 and one or more microphones to capture the audio data.

17. A method implemented in a computer system detecting occurrences of an event in a time series comprising a plurality of data points, each data point comprising data for a corresponding time in the time series, the method comprising:
for each data point in the sequence:
determining, using the data for the data point, a first conditional probability value that a transition occurred from an event not having started to the event being ongoing, and a second conditional probability value that a transition occurred from an event being ongoing to the event having ended; and
determining a marginal probability value that an event was ongoing at the time corresponding to the data point, the marginal probability value being determined using the first and second conditional probability values for the data point and a previously determined marginal probability value that an event was ongoing at a time corresponding to a data point preceding the data point in the time series.

18. A method according to claim 17, wherein the time series is a sequence of frames of audio or video data.
